(19) United States
(12) Patent Application Publication
(10) Pub. No.: US 2024/0396210 A1
(43) Pub. Date: Nov. 28, 2024

(54) ANTENNA APPARATUS

(71) Applicant: KMW INC., Hwaseong-si (KR)

(72) Inventors: Sung Hwan SO, Hwaseong-si (KR); Oh Seog CHOI, Hwaseong-si (KR); Yong Won SEO, Daejeon (KR); Seong Man KANG, Hwaseong-si (KR); Hyoung Seok YANG, Hwaseong-si (KR)

(73) Assignee: KMW INC., Hwaseong-si (KR)

(21) Appl. No.: 18/777,556

(22) Filed: Jul. 19, 2024

Related U.S. Application Data
(63) Continuation of application No. PCT/KR2023/001009, filed on Jan. 20, 2023.

(30) Foreign Application Priority Data
Jan. 21, 2022 (KR) 10-2022-0009394
Jan. 19, 2023 (KR) 10-2023-0007720

(51) Int. Cl. H01Q 3/32; H01Q 15/14

(52) U.S. Cl. CPC H01Q 3/32; H01Q 15/141

(57) ABSTRACT

The present invention relates to an antenna apparatus. In particular, the antenna apparatus comprises: a radiating element module including a plurality of antenna sub-arrays electrically connected to the front of an RF filter and arranged to implement antenna beamforming by building a predetermined number of RF chains; and a phase shifter which shifts a phase value by changing the length ratio of a physical transmission line to the plurality of antenna sub-arrays to a predetermined ratio, wherein each RF chain of the radiating element module is implemented such that the antenna sub-array is connected to one output terminal of two output terminals branching off from an input terminal of each RF chain and an additional antenna sub-array corresponding to the antenna sub-array is further arranged to be connected to the other output terminal. Accordingly, a beam with a narrow beam width and a high antenna gain may be radiated, thus providing advantages in production cost and process.

### TECHNICAL FIELD

The present disclosure relates to an antenna apparatus, and more particularly, to an antenna apparatus capable of improving an antenna gain by further including an additional antenna sub-array that is branched from the input stage of each RF chain, along with a plurality of antenna sub-arrays, and performing beam radiation by shifting the phase values of the antenna sub-array and the additional antenna sub-array so that the phase values are different from each other by using a phase shifter, in the antenna apparatus having a predetermined number of RF chains.

### BACKGROUND ART

A wireless communication technology, for example, a multiple input multiple output (MIMO) technology, is a technology for significantly increasing a data transmission capacity by using a plurality of antennas, and is a spatial multiplexing scheme in which a transmitter transmits different data through transmission antennas and a receiver distinguishes between transmission data through proper signal processing.

Accordingly, as both the number of transmission antennas and the number of reception antennas are increased, more data can be transmitted because a channel capacity is increased. For example, if the number of antennas is increased to 10, a channel capacity that is about 10 times compared to a current single antenna system is secured by using the same frequency band.

In 4G LTE-advanced, up to 8 antennas are used. In a current pre-5G stage, a product on which 64 or 128 antennas have been mounted is being developed. In 5G, it is expected that base station equipment having a much larger number of antennas will be used. This is called a massive MIMO technology. A current cell operation is 2-dimensional. In contrast, if the massive MIMO technology is introduced, 3D-beamforming is made possible, and the massive MIMO technology is also called full dimension (FD)-MIMO.

In particular, a plurality of array antenna elements may implement beamforming through an antenna radiation beam in order to provide an optimal service in accordance with a change in the use density of subscribers for each region and each time zone.

FIG. 1 is a conceptual view illustrating a form in which a transmission signal channel for 64T64R has been constructed by high-specification array antenna elements.

As illustrated in FIG. 1, a plurality of antenna sub-arrays are arranged in a vertical (V) direction to implement four RF chains, and several lines of the antenna sub-arrays are arranged in a horizontal (H) direction to construct four V-direction RF chains V1, V2, V3, and V4, so that a transmission signal channel for 64T64R is implemented.

If RF chains of which the number (i.e., the number of the plurality of antenna sub-arrays) is doubled are arranged, however, theoretically, a channel capacity can be additionally secured by the ratio of antenna sub-arrays that have been increased as described above, but a weight and a volume are suddenly increased because a power amplifier (PA) and a filter are increased at the same ratio. Furthermore, there is a problem in that the size of a box for heat dissipation is also additionally increased because the generation of heat is increased due to the increased RF chains.

### DISCLOSURE

### Technical Problem

The present disclosure has been contrived to solve the technical problems, and an object of the present disclosure is to provide an antenna apparatus capable of implementing beamforming having a great gain, compared to an antenna apparatus not including an additional antenna sub-array, by further constructing an additional antenna sub-array for a branch from the input stage of each RF chain, along with the plurality of antenna sub-arrays that are arranged to construct a predetermined number of RF chains, and performing beam radiation by shifting the phase values of the antenna sub-arrays and the additional antenna sub-array so that the phase values are different from each other by using a phase shifter.

Furthermore, another object of the present disclosure is to provide an antenna apparatus capable of implementing beamforming having a linear phase distribution in radiating the antenna beams of the plurality of antenna sub-arrays and an additional antenna sub-array after shifting the phases of the plurality of antenna sub-arrays and the additional antenna sub-array by using the phase shifter.

Objects of the present disclosure are not limited to the aforementioned objects, and the other objects not described above may be evidently understood from the following description by those skilled in the art.

### Technical Solution

An antenna apparatus according to an embodiment of the present disclosure includes a radiation element module including a plurality of antenna sub-arrays provided to be electrically connected to a front of an RF filter and arranged to implement antenna beamforming by constructing a predetermined number of RF chains and a phase shifter configured to shift a phase value by changing the ratio of the lengths of physical transmission lines for the plurality of antenna sub-arrays at a predetermined ratio. Each of the RF chains of the radiation element module is further arranged so that the antenna sub-array is connected to any one of two output stages that are branched from the input stage of each of the RF chains and an additional antenna sub-array corresponding to the antenna sub-arrays is connected to the output stage of the other of the two output stages.

In this case, the phase shifter may implement a linear phase distribution based on the predetermined ratio with respect to an reference phase surface by performing beam radiation by differently shifting phase values of the plurality of antenna sub-arrays and the additional antenna sub-array in a transmission line that constitutes any one of the input stage of each of the RF chains and the two output stages that have been branched.

Furthermore, when antenna beamforming through a transmission signal channel for 32T32R is implemented, the plurality of antenna sub-arrays may constitute two RF chains and are arranged to be spaced apart from each other in a vertical (V) direction for each chain. The additional antenna sub-array may be arranged to be spaced apart from the antenna sub-array in the V direction so that the additional antenna sub-array is branched from the input stage of each of the two RF chains along with the antenna sub-arrays.

Furthermore, the phase shifter may change the physical length of each of the transmission lines connected to the plurality of antenna sub-arrays and the additional antenna sub-array corresponding to each of the RF chains for power feeding.

Furthermore, the phase shifter may include a variable switch panel including a first electrification pattern terminal second electrification pattern terminal.

The radiation element module may include an antenna board assembly in which the plurality of antenna sub-arrays and the plurality of additional antenna sub-arrays are arranged and a transmission line in which the first electrification pattern terminal and the second electrification pattern terminal comes into contact with each other is coupled in the form of a plurality of power feeding strip lines made of a conductive material.

Furthermore, the plurality of power feeding strip lines of the antenna board assembly may be provided in a variable circuit board on which a variable circuit having a first power failure point and a second power failure point that are electrified by the first electrification pattern terminal and second electrification pattern terminal of the variable switch panel is patternized and printed.

Furthermore, the variable circuit board may be provided in the form of a printed circuit board made of an FR-4 material.

Furthermore, the plurality of power feeding strip lines may include a rear power feeding strip line electrically connected to the variable circuit of the variable circuit board including two input stages so that power is supplied from at least two places, and a front power feeding strip line electrically connected to the rear power feeding strip line, branched and extended to have at least two output stages, and connected to the plurality of antenna sub-arrays and the plurality of additional antenna sub-arrays.

Furthermore, the phase shifter may implement a phase shift value having a predetermined ratio based on a location where the first electrification pattern terminal and the second electrification pattern terminal come into contact with the transmission line as the variable switch panel is rotated.

Furthermore, the radiation element module may include an antenna board assembly including a reflecting panel provided to forward reflect antenna beams that are radiated by the plurality of antenna sub-arrays and the additional antenna sub-arrays and a rear panel and a front panel stacked and coupled to a rear surface and front surface of the reflecting panel, and the plurality of power feeding strip lines arranged in any one of strip line installation slits that penetrate the reflecting panel or that are processed in the rear panel and the front panel in a slit form, arranged for an electrical connection between the plurality of power feeding strip lines and the RF filter, and made of a conductive material. The material of each of the front panel and the rear panel may include a plastic resin material of a heterogeneous material that is different from a material of the reflecting panel. The rear panel and front panel of the antenna board assembly may be integrally manufactured by a dual injection method on the basis of the reflecting panel.

Furthermore, a variable circuit board on which a variable circuit having at least two power failure points may be patternized and printed so that the two power failure: points constitute a part of the physical transmission line that is changed by the phase shifter is constructed on a front surface of the front panel.

### Advantageous Effects

According to the antenna apparatus according to an embodiment of the present disclosure, beamforming is implemented by constructing the additional antenna sub-array in addition to an antenna sub-array that is provided to construct a basic RF chain, and shifting into a phase value having a linear phase distribution at plural places of a transmission line that constitutes two output stages branched from the input stage of the RF chain by using the phase shifter. Accordingly, there are advantages in that beamforming can be implemented to enable performance according to the specifications of the antenna apparatus and the antenna apparatus is advantageous in terms of a cost and a process compared to the existing high-specification antenna apparatus.

### DESCRIPTION OF DRAWINGS

FIG. 1 is a conceptual view illustrating a form in which a transmission signal channel for 64T64R has been constructed by high-specification array antenna elements.

FIG. 2 is a perspective view illustrating an external appearance of an antenna apparatus according to an embodiment of the present disclosure.

FIG. 3 is an exploded perspective view of a radome panel which has been separated, among the components of FIG. 2.

FIGS. 4A and 4B are exploded perspective views of a front part and rear part of a radiation element module.

FIG. 5 are exploded perspective views of an antenna board assembly and a power feeding strip line coupled thereto, among the components of the radiation element module of FIGS. 4A and 4B.

FIG. 6 is a cross-sectional view for describing an operating relation of a phase shifter among the components of the antenna apparatus according to an embodiment of the present disclosure.

FIG. 7 is a cutaway perspective view illustrating a portion “A” in FIG. 6.

FIG. 8 is a plan view for describing power feeding according to a variable circuit board and a variable switch panel, among the components of the phase shifter of FIG. 6, and a principle in which the phase value of the phase shifter is shifted.

FIG. 9 is an exploded perspective view illustrating an antenna apparatus according to another embodiment of the present disclosure.

FIG. 10 is a front view of FIG. 9.

FIGS. 11A and 11B are exploded perspective views of a front part and a rear part, which illustrate a phase shifter among the components of the antenna apparatus according to another embodiment of the present disclosure.

FIGS. 12A and 12B are exploded perspective views of a front part and a rear part, which illustrate a detailed coupling relation of a phase shift driving motor among the components of the phase shifter.

FIG. 13 is a circuit diagram and phase difference diagram for describing the principle of a form of a phase shift that is performed in an RF stage by using the phase shifter of the antenna apparatus according to embodiments of the present disclosure.

FIG. 14 is a conceptual diagram for describing a transmission signal channel for 32T32R and phase shift form of the antenna apparatus according to embodiments of the present disclosure.

<Description of reference numerals>

| | |
|---|---|
| 210: RF filter | 211: unit RF filter body |
| 310: antenna board assembly | 310A: reflecting panel |
| 310B: rear panel | 310C: front panel |
| 311B: rear power feeding | 311C: front power |
| strip line | feeding strip line |
| 350: antenna sub-array | 350′: additional antenna |
| | sub-array |
| 500: phase shifter | 510: phase shift driving |
| | motor |
| 520: horizontal mounting bar | 530: vertical |
| | mounting bar |
| 540: variable switch panel | 590: front surface |
| | horizontal moving bar |

### BEST MODE

Hereinafter, an antenna apparatus according to embodiments of the present disclosure is described in detail with reference to the accompanying drawings.

In adding reference numerals to the components of each drawing, it should be noted that the same components have the same reference numerals as much as possible even if they are displayed in different drawings. Furthermore, in describing embodiments of the present disclosure, when it is determined that a detailed description of the related well-known configuration or function hinders understanding of an embodiment of the present disclosure, the detailed description thereof will be omitted.

In describing components of an embodiment of the present disclosure, terms, such as a first, a second, A, B, (a), and (b), may be used. Such terms are used only to distinguish one component from another component, and the essence, order, or sequence of a corresponding component is not limited by the terms. All terms used herein, including technical or scientific terms, have the same meanings as those commonly understood by a person having ordinary knowledge in the art to which the present disclosure pertains, unless defined otherwise in the specification. Terms, such as those commonly used and defined in dictionaries, should be construed as having the same meanings as those in the context of a related technology, and are not construed as having ideal or excessively formal meanings unless explicitly defined otherwise in the specification.

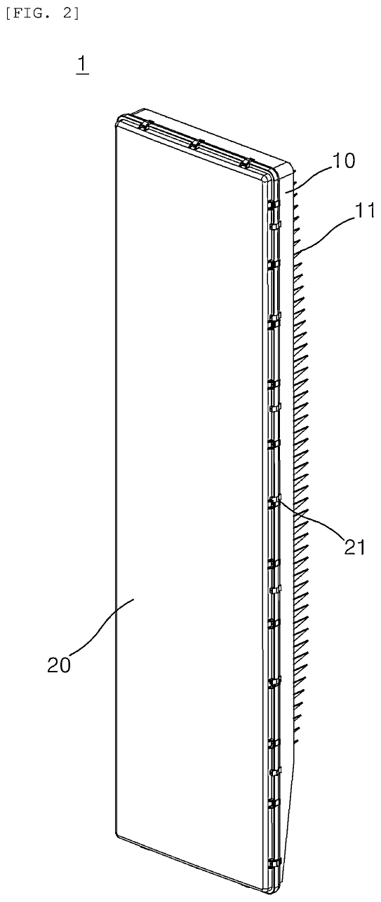

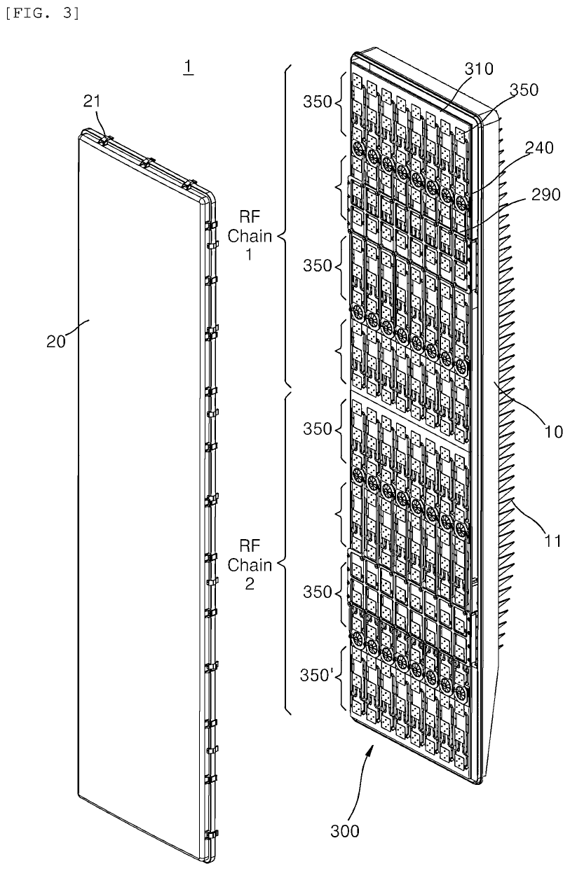

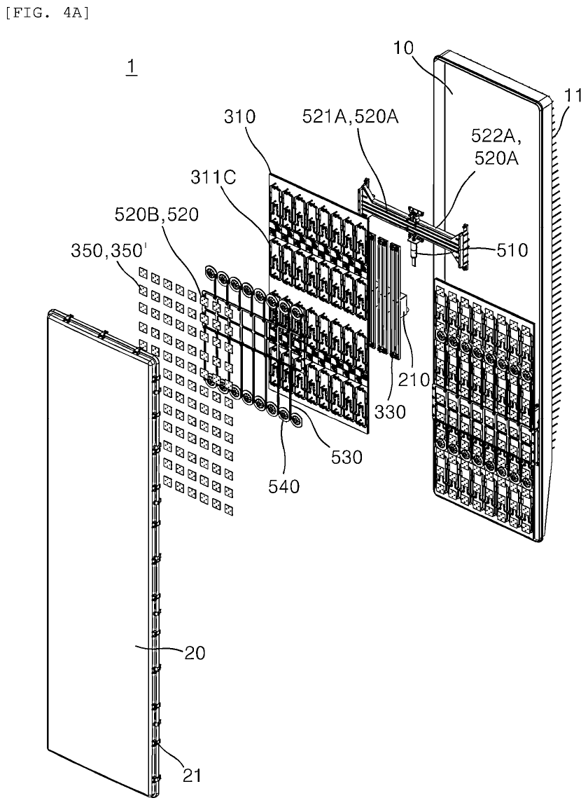

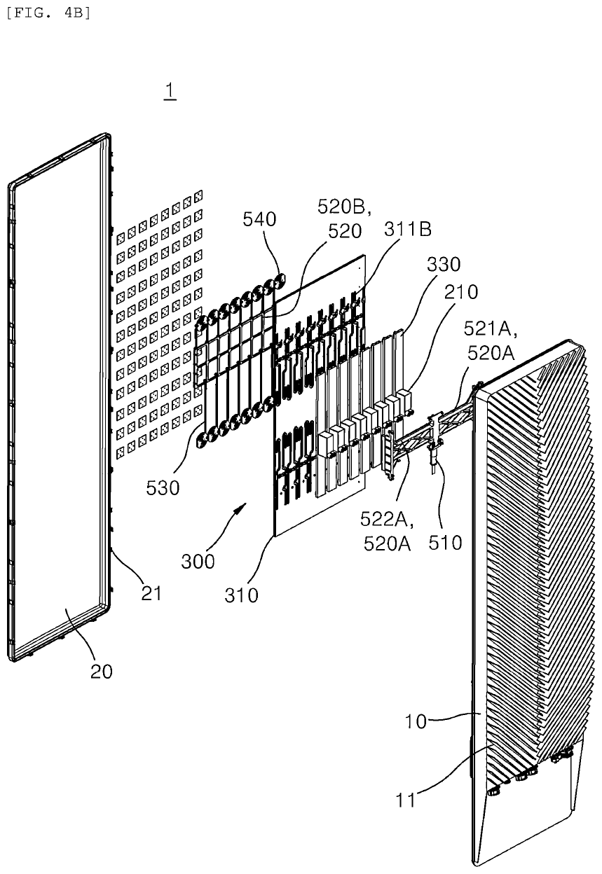

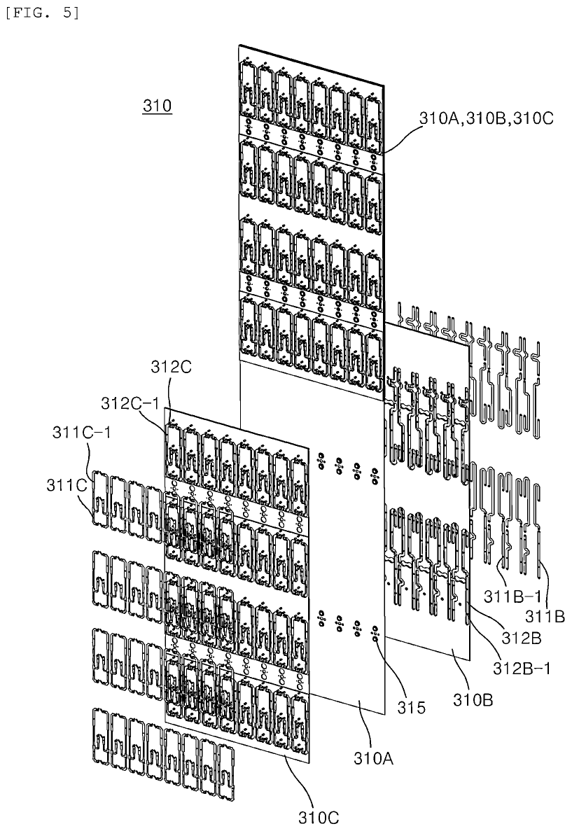

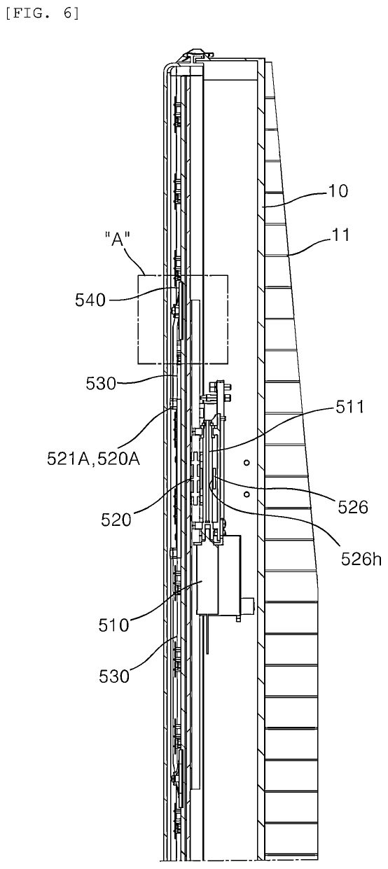

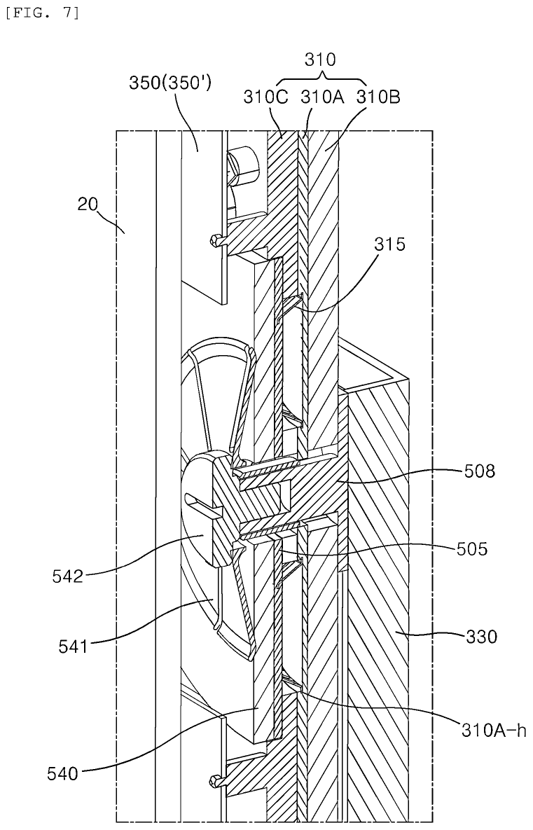

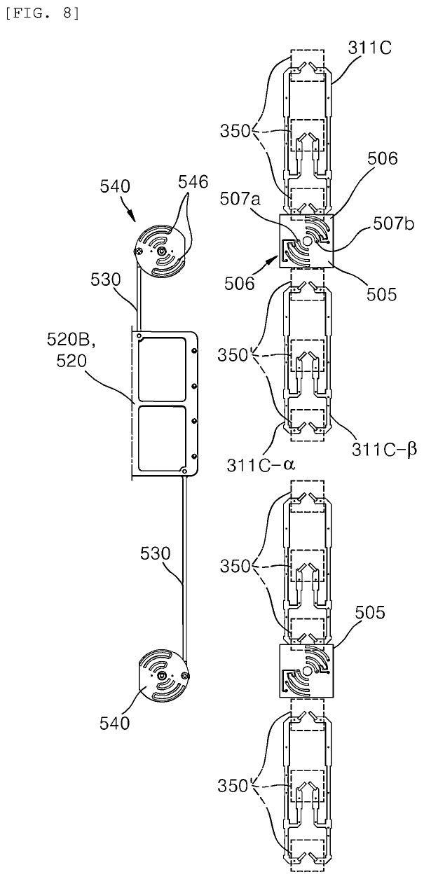

FIG. 2 is a perspective view illustrating an external appearance of an antenna apparatus according to an embodiment of the present disclosure. FIG. 3 is an exploded perspective view of a radome panel which has been separated, among the components of FIG. 2. FIGS. 4A and 4B are exploded perspective views of a front part and rear part of a radiation element module. FIG. 5 are exploded perspective views of an antenna board assembly and a power feeding strip line coupled thereto, among the components of the radiation element module of FIGS. 4A and 4B. FIG. 6 is a cross-sectional view for describing an operating relation of a phase shifter among the components of the antenna apparatus according to an embodiment of the present disclosure. FIG. 7 is a cutaway perspective view illustrating a portion “A” in FIG. 6. FIG. 8 is a plan view for describing power feeding according to a variable circuit board and a variable switch panel, among the components of the phase shifter of FIG. 6, and a principle in which the phase value of the phase shifter is shifted.

An antenna apparatus according to an embodiment of the present disclosure may be an antenna apparatus into which a multiple-input multiple-output (MIMO) technology has been incorporated.

The MIMO technology is a technology for significantly increasing a data transmission capacity by using a plurality of antenna sub-arrays, and is a spatial multiplexing scheme in which a transmitter transmits different data through transmission antennas and a receiver distinguishes between transmission data through proper signal processing. Accordingly, more data can be transmitted because a channel capacity may be increased as the numbers of transmission and reception antennas are simultaneously increased. For example, if the number of antennas is increased to 10, a channel capacity that is about 10 times compared to a single antenna system is secured by using the same frequency band.

In particular, in an antenna apparatus, TRx modules (not illustrated) that each perform transmitter and receiver functions may be vertically (V)-horizontally (H) arranged in up and down vertical directions and left and right horizontal directions thereof, and a plurality of antenna elements 350 electrically connected to each TRx module may be arranged. In this case, the channel capacity of each TRx module may be redefined as an “RF chain”. The plurality of antenna elements 350 may be redefined as an “antenna sub-array 350” as a group unit of the plurality of antenna elements 350 that are arranged for antenna beamforming. Hereinafter, it is to be noted that the term “TRx module” may be interchangeably as the same meaning as an “RF chain”, and the definition of the arrangement of the antenna elements 350 that construct RF communication for each RF chain may be basically interchangeably used with the term “antenna sub-array”.

As referenced in FIG. 3, two RF chains may be constructed in the V direction. In this case, three antenna sub-arrays 350 may be arranged in the V direction for each RF chain.

Furthermore, an additional antenna sub-array 350′ having the same specifications and same number as the antenna sub-array 350 may be further arranged in each RF chain.

In this case, each RF chain is constructed through a transmission line (a power feeding strip line 311B, 311C that is described later) so that the transmission line is branched from one input stage to two output stages. In this case, the antenna sub-array 350 may be connected to any one of the two output stages, and the additional antenna sub-array 350′ may be further arranged in the other of the two output stages.

Accordingly, a total of 24 antenna sub-arrays 350 and additional antenna sub-arrays 350′ may be arranged in the V direction. In general, if three antenna sub-arrays 350 or 350′ arranged in the V direction are related to one TRx and a sub-arrays 350 or 350′ are a total of eight antenna arranged in the H direction, a transmission channel for 64T64R is constructed. In an embodiment of the present disclosure, however, if a total of eight antenna sub-arrays 350 and additional antenna sub-arrays 350′ are arranged in the H direction, a transmission channel for 32T32R may be constructed in that the antenna sub-arrays and the additional antenna sub-arrays are related to one TRx.

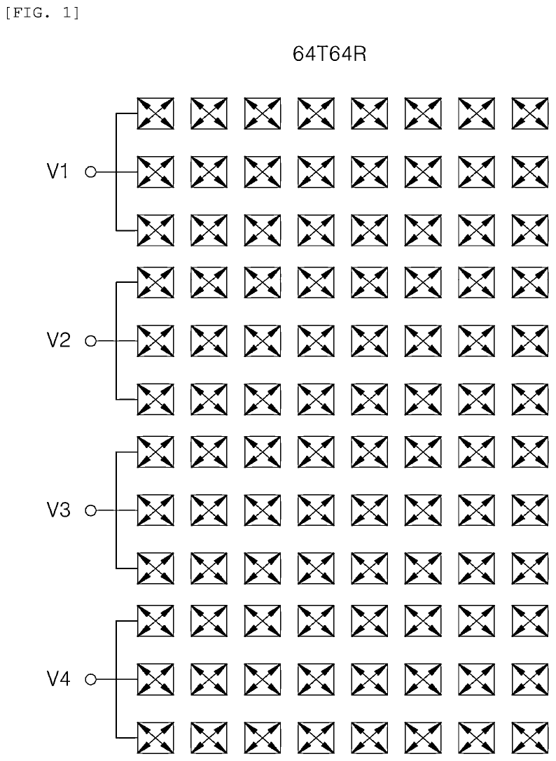

That is, a total of twenty-four antenna elements 350 are arranged in the V direction without distinction of the names of the antenna sub-array 350 and the additional antenna sub-array 350′. If a phase shifter 500 that is described later is not provided, as already described with reference to FIG. 1, in general, there is meaning as an antenna apparatus that implements the transmission signal channel for 64T64R (i.e., a total of four RF chains). However, in an embodiment of the present disclosure, after a transmission line is constructed to be branched from one input stage two output stages, each antenna sub-array 350 and each additional antenna sub-array 350′ may be provided in portions corresponding to the two output stages, and two RF chains may be implemented through a phase shift using the phase shifter 500 at two places of the transmission line.

To this end, as referenced in FIGS. 3 to 6, the antenna apparatus 1 according to an embodiment of the present disclosure includes a radiation element module 300 including the plurality of antenna sub-arrays 350 and the additional antenna sub-array 350′ that are provided to be electrically connected to the front of an RF filter 210 and that are arranged to implement antenna beamforming and the phase shifter 500 that shifts the phase values of the plurality of antenna sub-arrays 350 and the additional antenna sub-array 350′ by changing the ratio of the lengths of physical transmission lines for the plurality of antenna sub-arrays 350 and the additional antenna sub-array 350′ at a predetermined ratio.

In this case, the radiation beams of the antenna sub-array 350 and the additional antenna sub-array 350′, which are radiated as the phase values shifted by the phase shifter 500, can implement beamforming having an improved gain of +3 dB, compared to a conventional case in which a beam is radiated through the antenna sub-array for each RF chain without a branch from the input stage of each RF chain to two output stages.

That is, the radiation beams of the antenna sub-array 350 and the additional antenna sub-array 350′, which are radiated as the phase values shifted by the phase shifter 500, can implement performance of an antenna apparatus, which has an improved gain of +3 dB, compared to an antenna apparatus having the same number of RF chains.

In the antenna apparatus 1 according to an embodiment of the present disclosure, the additional antenna sub-array may be further arranged in the radiation element module 300 in the V direction so that a branch is performed, along with the plurality of antenna sub-arrays that have been arranged to implement predetermined antenna beamforming for each predetermined number of RF chains in order to implement a transmission signal channel for 32T32R.

In this case, it may be interpreted that the phase shifter 500 has the aforementioned improved gain by performing beam radiation by differently shifting the phase values of the plurality of array antenna elements 350 and the additional array antenna element 350 of each RF chain.

It is like a configuration that a high-specification antenna apparatus provided to implement a transmission signal channel for 64T64R without having the phase shifter 500, in general, is made to be capable of implementing a transmission signal channel for 32T32R by applying a unique phase shift method of the present disclosure by adding the phase shifter 500, but radiating an antenna beam having the improved gain. However, in this case, a transmission line needs to be constructed so that the transmission line is branched into the two output stages compared to the input stage of each RF chain. Furthermore, the phase shift values need to implement a linear distribution with reference to a reference same phase surface by designing the antenna apparatus so that the phase shifter 500 shifts a No. 1 phase in the transmission line before the transmission line is branched into the two output stages and shifts a No. 1 phase in any one of transmission lines that are connected to the two output stages after being branched.

In this case, in a MIMO antenna apparatus for mobile communication, in general, the plurality of antenna sub-arrays 350 are designed as a plurality of dual polarization antenna module arrays in order to reduce a fading influence by multiple paths and perform a polarization diversity function.

More specifically, as referenced in FIGS. 2 to 6, the antenna apparatus 1 according to an embodiment of the present disclosure may include an antenna housing part 10 that form external appearances of the left and right sides and rear of the antenna apparatus, and a radome panel 20 that forms an external appearance of the front of the antenna apparatus, that is provided to shield an opened front surface of the antenna housing part 10, and that protects internal parts (including the RF filter 210 and an antenna board assembly 310 that are described later), which are provided in an internal space of the antenna housing part 10, against the outside.

The radome panel 20 may be detachably fixed to the front end of the antenna housing part 10 by a plurality of clips 21 for coupling that are provided at the end of the radome panel.

In this case, functions and detailed characteristics of the antenna housing part 10 and the radome panel 20 have very low correlation with technical characteristics of an embodiment of the present disclosure, and thus detailed descriptions thereof are omitted.

The RF filter 210 may be stacked and disposed on a front surface of a main board (not illustrated) that is disposed in the internal space of the antenna housing part 10, and may be provided as a plurality of unit RF filter bodies (reference numeral not indicated). In this case, the plurality of unit RF filter bodies may be disposed to correspond to the number of the plurality of antenna sub-arrays 350 and additional antenna sub-arrays 350′, which are arranged in the H direction thereof and are described later.

Meanwhile, the antenna apparatus 1 according to an embodiment of the present disclosure may further include the radiation element module 300 including the plurality of antenna sub-arrays 350 and the additional antenna sub-array 350′ that are provided to be electrically connected to the front of the RF filter 210 described above and that are arranged to implement antenna beamforming.

The radiation element module 300 may include the antenna board assembly 310 to a front surface of which the plurality of antenna sub-arrays 350 and the additional antenna sub-arrays 350′ are fixed to be V-H arranged.

In this case, the antenna board assembly 310 may include a reflecting panel 310A that is provided to forward reflect antenna beams radiated by the plurality of antenna sub-arrays 350 and the additional antenna sub-arrays 350′, and a rear panel 310B and a front panel 310C that are stacked and coupled to a rear surface and front surface of the reflecting panel 310A.

It is preferred that the reflecting panel 310A is made of an electromagnetic shielding material that does not transmit an antenna beam. It is preferred that the rear panel 310B and the front panel 310C provided on the rear surface and front surface of the reflecting panel 310A are made of a plastic resin material, which is a non-conductive material and may be easily manufactured integrally with the reflecting panel 310A by a molding process.

More specifically, the reflecting panel 310A is made of a heterogeneous material different from a material that constitutes the rear panel 310B and the front panel 310C, and may be made of a plastic resin material by which the rear panel 310B and the front panel 310C can be easily manufactured integrally by a dual injection method on the basis of the reflecting panel 310A.

For reference, conventionally, the antenna board assembly 310 is made of a common PCB material and provided in the form of a printed circuit board. A power feeding line (a transmission line that is a component corresponding to a power feeding strip line of the present disclosure, which is described later) is printed and formed on a front surface or rear surface of the printed circuit board by a pattern printing process.

If the power feeding line is printed and formed on the front surface or rear surface of the printed circuit board by the pattern printing process, there is a problem in that an insertion loss is increased because the power feeding line is directly formed in a dielectric layer having a predetermined dielectric constant.

The antenna apparatus 1 according to an embodiment of the present disclosure can create an advantage in that an insertion loss can be minimized because, compared to a conventional technology, the antenna board assembly 310 is integrally molded as the rear panel 310B and the front panel 310C made of a plastic resin material on the rear surface and front surface of the reflecting panel 310A by excluding a printed circuit board made of a common PCB material, but a power feeding strip line 311B, 311C that performs the function of a transmission line is accommodated in an air dielectric layer.

Meanwhile, in the antenna apparatus according to an embodiment of the present disclosure, as referenced in FIG. 5, the radiation element module 300 may further include a plurality of rear power feeding strip lines 311B that are arranged in strip line installation slits 312B (hereinafter denoted as “rear installation slits”) each processed in the rear panel 310B in a slit form and front power feeding strip lines 311C that are arranged in strip line installation slits 312C (hereinafter denoted as “front installation slits”) each processed in the front panel 310C in a slit form.

A plurality of pin fixing holes 311B-1 and 311C-1 are formed in the rear power feeding strip line 311B and the front power feeding strip line 311C, respectively. A plurality of fixing pins 312B-1 and 312C-1 that are pressed in and fixed to the pin fixing holes 311B-1 and 311C-1 of the rear power feeding strip line 311B and the front power feeding strip line 311C, respectively, may be formed within the rear installation slits 312B and the front installation slits 312C, respectively.

In this case, the rear installation slit 312B and the front installation slit 312C may be formed to penetrate in forward and backward directions thereof so that the rear power feeding strip line 311B and the front power feeding strip line 311C are accommodated in the rear installation slit and the front installation slit through the medium of an air layer, or may each be processed and formed in the form of a groove having a thickness, which is at least greater than the thickness of each of the rear power feeding strip line 311B and the front power feeding strip line 311C.

As referenced in FIG. 8, the front power feeding strip lines 311C may be disposed over and under one variable circuit board 505. In the antenna apparatus 1 according to an embodiment of the present disclosure, two variable circuit boards 505 are provided for each RF channel. Four front power feeding strip lines 311C may be disposed over and under the two variable circuit boards 505 that are disposed to be spaced apart from each other in the V direction. In this case, the variable circuit board 505 plays a role constitute a part of a physical transmission line, which is changed by the phase shifter 500 that is described later.

Furthermore, the front power feeding strip line 311C may include left front power feeding strip lines 311C-x and right front power feeding strip lines 311C-B that are electrically connected to the variable circuit board 505 by the rear power feeding strip line 311B that is connected to extension stages extended from the two input stages 507a and 507b of the variable circuit board 505 and that are branched and extended upward and downward centering around the variable circuit board 505 so that the left front power feeding strip line and the right front power feeding strip line have at least two output stages.

Although not illustrated in detail in the drawings, the rear power feeding strip line 311B has one end connected to each of the extension stages that are extended from the two input stages 507a and 507b of the variable circuit board 505, and has the other end electrically connected to the left front power feeding strip line 311C-x and the right front power feeding strip line 311C-B that are disposed over and under the variable circuit board 505, respectively. The rear power feeding strip line plays a role to branch and transmit a power feeding signal through a low pass filter 330 that is described later.

Meanwhile, as referenced in FIGS. 2 to 6, the antenna apparatus 1 according to an embodiment of the present disclosure may further include the phase shifter 500 that implements a desired phase shift value by changing phases by a predetermined value with respect to the same reference phase surface by physically changing the length of the transmission lines of the power feeding strip lines 311B and 311C that are connected from the RF filter 210 to the plurality of antenna sub-arrays 350 and the additional antenna sub-arrays 350′.

The phase shifter 500 may include a phase shift driving motor 510 that is fixed between the unit RF filter bodies on the rear surface side of the antenna board assembly 310, a horizontal mounting bar 520 that horizontally moves in up and down directions thereof on the rear surface and front surface sides of the antenna board assembly 310 in the rotation direction of the motor shaft of the phase shift driving motor 510, a plurality of vertical mounting bars 530 each having one end connected to the horizontal mounting bar 520 and the other end hinged and connected to a variable switch panel 540 that is described later, and a variable switch panel 540 that is rotatably provided on a front surface of the variable circuit board 505 fixed to a front surface of the front panel 310C of the antenna board assembly 310.

In this case, as referenced in FIGS. 4A and 4B, the horizontal mounting bar 520 may include a rear horizontal mounting bar 520A that moves in up and down directions thereof while maintaining left and right horizontality on the rear surface side of the antenna board assembly 310, and a front horizontal mounting bar 520B that is connected to left and right ends of the rear horizontal mounting bar 520A through external parts of the antenna board assembly 310 at left and right side ends thereof and that moves in up and down directions thereof while maintaining left and right horizontality on the front surface side of the antenna board assembly 310 in conjunction with the rear horizontal mounting bar 520A.

The rear horizontal mounting bar 520A may perform a function for supporting up and down moving at the ends of the antenna housing part 10 within the left and right sides thereof. The front horizontal mounting bar 520B is connected to the rear horizontal mounting bar 520A, may be provided with up and down moving forces, and may also perform a function for providing a connection point to which the other end of each of the plurality of vertical mounting bars 530 is connected.

As referenced in FIG. 6, the phase shift driving motor 510 may be disposed to have a motor rotation shaft in up and down directions thereof in the rear horizontal mounting bar 520A. A rotation screw pole 511 may be axially coupled to the motor rotation shaft of the phase shift driving motor 510 and may be provided rotatably toward one side or the other side thereof.

In this case, when the rotation screw pole 511 is engaged and rotated with a female screw thread of a screw pole through hole 526h included in the screw guide mounting block 526 in the state in which the phase shift driving motor 510 has been fixed within the antenna housing part 10, the screw guide mounting block 526 moves the rear horizontal mounting bar 520A in up and down directions thereof while being moved in up and down directions thereof.

Detailed descriptions of a connection structure of the rear horizontal mounting bar 520A and the front horizontal mounting bar 520B and a connection structure of the front horizontal mounting bar 520B and the plurality of vertical mounting are bars 530 substituted with descriptions of the components of an antenna apparatus 1A according to another embodiment of the present disclosure.

The variable circuit board 505 is a kind of printed circuit board made of an FR-4 material. A variable circuit 506 having at least one power failure point at which the phase of a frequency may be changed through a transmission line may be patternized and printed on the front surface of the variable circuit board. At least one electrification terminal pattern 546 that energizes the power failure point of the variable circuit board 505 may be printed and formed on a rear surface of the variable switch panel 540.

More specifically, as referenced in FIG. 8, the variable circuit 506 that is patternized and printed on the variable circuit board 505 may receive power feeding signals from the two input stages 507a and 507b. The power failure points may be formed at two places of a portion of the variable circuit board that is patternized and printed and extended from the input stages 507a and 507b, respectively.

In this case, the variable switch panel 540 is provided on the front surface side of the variable circuit board 505 in a way to be always elastically supported through the medium of an elastic member 541 that is provided as a leaf spring. The elastic member 541 may be elastically supported toward the variable switch panel 540 by being hinged and fixed by a hinge screw 542.

The elastic member 541 can prevent an error attributable to the separation of a contact point because an electrification terminal pattern 546 of the variable switch panel 540 is rotated without being spaced apart from the variable circuit 506 of the variable circuit board 505 as described above.

Referring to FIGS. 4A and 4B, as described above, the variable circuit board 505 that is provided as the type of a panel made of a material capable of shielding electromagnetic waves, among the components of the phase shifter 500, may be fixed to the front surface of the reflecting panel 310A.

As referenced in FIG. 7, the variable circuit board 505 may be pressed in and fixed to a board installation boss 508 that is fixed to penetrate the antenna board assembly 310 in forward and backward directions thereof. The variable switch panel 540 may also be screwed and fastened to a front part of the board installation boss 508 by using the hinge screw 542.

Meanwhile, as referenced in FIGS. 4A and 4B, the antenna apparatus 1 according to an embodiment of the present disclosure may further include a low pass filter (LPF) 330 that is connected to an output port (not illustrated) of the unit RF filter body and that is connected to each of the input stages 507a and 507b of the variable circuit board 505, which are provided for power feeding to the plurality of power feeding strip lines 311B, 311C.

The low pass filter 330 is a filter for removing high frequency noise. The low pass filter is provided as a kind of pipe form, and may be provided so that the top and bottom of the low pass filter are connected to the portions of the input stages 507a and 507b of the variable circuit board 505 on upper and lower sides thereof, respectively.

Meanwhile, referring to FIGS. 5 and 7, a plurality of ground washers 315 may be disposed in a pair of units on the front surface of the reflecting panel 310A corresponding to the input stage 507a, 507b of the variable circuit board 505, among the top and bottom of the low pass filter 330, and may perform a ground (GND) function. In order to install the plurality of ground washers 315, a washer installation groove 310A-h may be formed to be depressed backward in the front surface of the reflecting panel 310A.

As referenced in FIGS. 6 and 8, when the phase shift driving motor 510 is electrically operated and the rotation screw pole 511 is rotated toward one side or the other side thereof, the phase shifter 500 constructed as above is moved upward or downward in the rotation direction of the screw guide mounting block 526. The rear horizontal mounting bar 520A to which the screw guide mounting block 526 has been fixed and the front horizontal mounting bar 520B fixed to the rear horizontal mounting bar are moved upward or downward while maintaining left and right horizontality. As the plurality of vertical mounting bars 530 are simultaneously moved in up and down directions thereof, the variable switch panel 540 coupled to the ends of the plurality of vertical mounting bars is rotated.

Accordingly, a phase shift value can be implemented through a change in the length of the physical transmission of the variable circuit board 505 and the front power feeding strip line 311C.

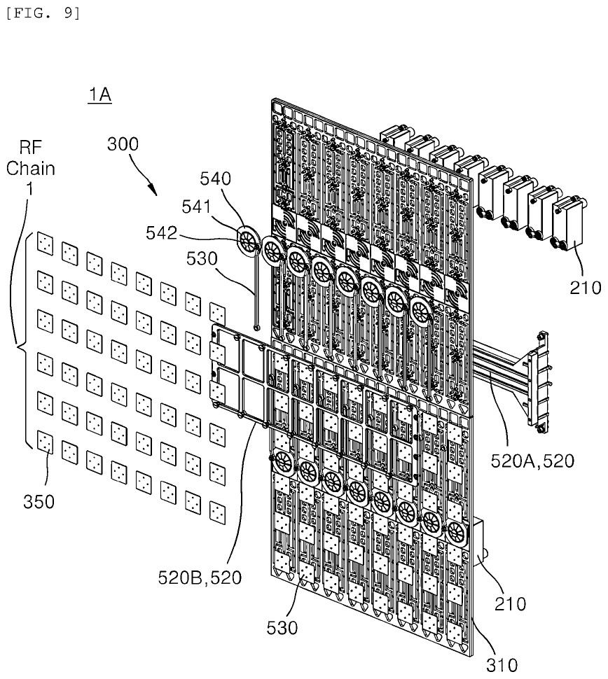

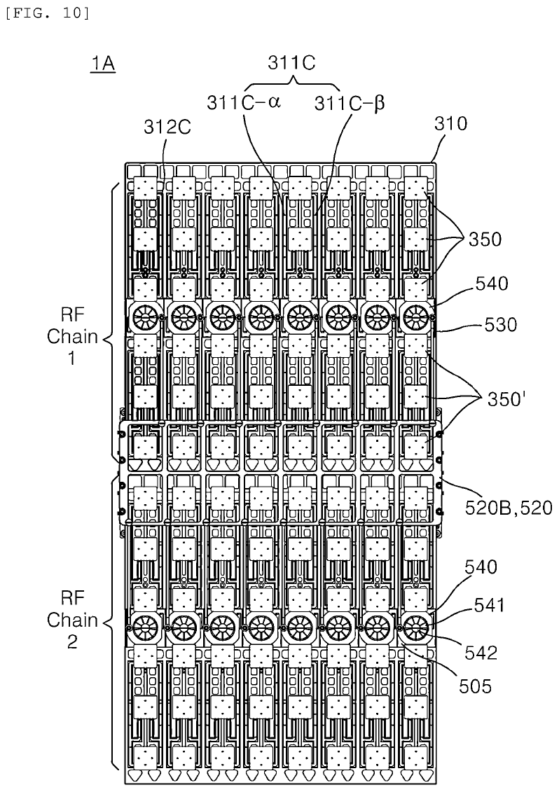

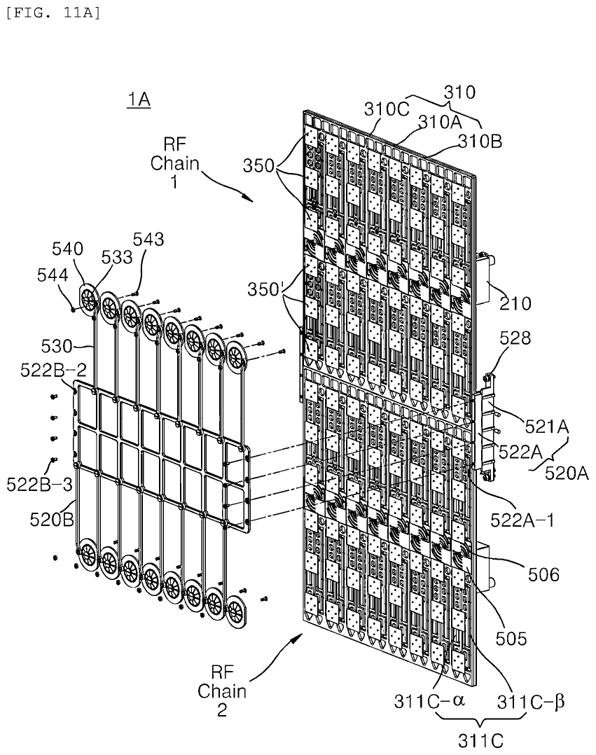

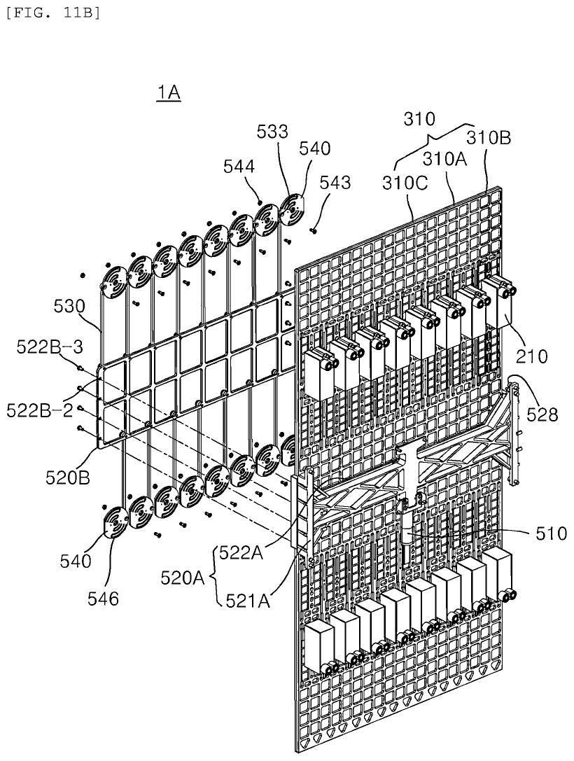

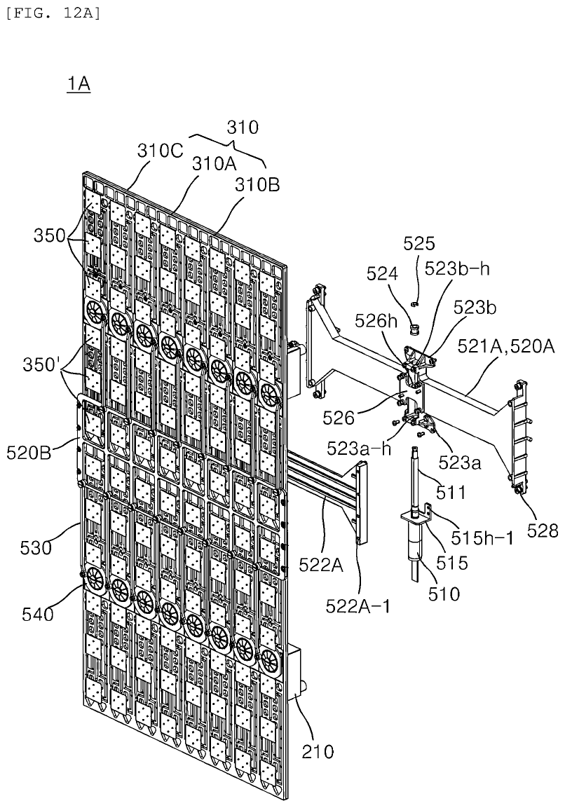

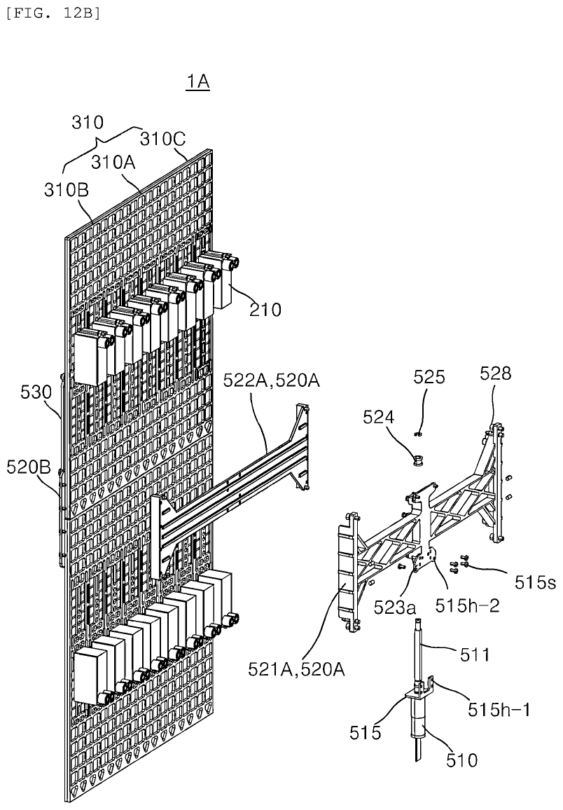

FIG. 9 is an exploded perspective view illustrating an antenna apparatus according to another embodiment of the present disclosure. FIG. 10 is a front view of FIG. 9. FIGS. 11A and 11B are exploded perspective views of a front part and a rear part, which illustrate a phase shifter among the components of the antenna apparatus according to another embodiment of the present disclosure. FIGS. 12A and 12B are exploded perspective views of a front part and a rear part, which illustrate a detailed coupling relation of a phase shift driving motor among the components of the phase shifter.

The antenna apparatus 1 described with reference to FIGS. 2 to 8 according to an embodiment of the present disclosure is an embodiment in which a transmission channel for 32T32R that implements predetermined phase shift values simultaneously by the two phase shifters 500 is constructed. In contrast, another embodiment 1A of the present disclosure may be defined as an embodiment in which a transmission channel for 16T16R is constructed by one phase shifter 500.

That is, the antenna apparatus 1A according to another embodiment of the present disclosure is an embodiment in which the antenna sub-array 350 and the additional antenna sub-array 350′ are arranged so that the two RF chains are constructed substantially in the V direction, but that achieves the same effect as that when a transmission signal channel for 16T16R is implemented by implementing one RF chain if an antenna beam is radiated by a change into a desired phase shift value by the phase shifter 500, when compared to the antenna apparatus 1 that has been referred in FIGS. 2 to 8 according to an embodiment of the present disclosure.

Hereinafter, the antenna apparatus 1A according to another embodiment of the present disclosure is described in a form in which a technology that includes a difference other than the aforementioned differences, compared to the embodiment 1 of the present disclosure, or that is not sufficient in the description portion of the embodiment 1 of the present disclosure is additionally described.

As referenced in FIGS. 9 to 12B, the antenna apparatus 1A according to another embodiment of the present disclosure may have a difference in which a low pass filter (not illustrated) is embedded and installed within a portion that is adjacent to the output port of the RF filter 210, unlike in the embodiment 1 of the present disclosure.

However, the low pass filter is not essentially embedded and installed within the RF filter 210. The front power feeding strip line 311C may be provided to be directly electrically connected to the variable circuit board 505. The rear power feeding strip line 311B that is provided between the rear panel 310B and the reflecting panel 310A in the embodiment 1 of the present disclosure may be deleted, or the low pass filter may be provided on the rear power feeding strip line 311B so that the low pass filter is integrally formed therewith.

Meanwhile, as referenced in FIG. 10, the antenna apparatus 1A according to another embodiment of the present disclosure may include only a single phase shifter 500 and simultaneously shift the phase values of two RF chains (RF Chain 1 and RF Chain 2). This is different from the antenna apparatus 1 according to an embodiment of the present disclosure, which simultaneously shifts the phase values of the two RF chains by using the two phase shifters 500.

Furthermore, in the antenna apparatus 1A according to another embodiment of the present disclosure, as referenced in FIGS. 11A to 12B, a horizontal mounting bar 520, among the components of the phase shifter 500, may include a rear horizontal mounting a bar 520A and front horizontal mounting bar 520B.

The rear horizontal mounting bar 520A may include a support mounting bar 521A that is provided to have both ends supported against the sidewalls of an internal space of the antenna housing part on the left and right sides thereof, and a fixing mounting bar 522A that is coupled to a front surface of the support mounting bar 521A and that has both ends on the left and right sides thereof at which a plurality of screw fastening holes 522A-1 for fixing with the front horizontal mounting bar 520B are formed.

In this case, a plurality of screw through holes 522B-2 may be formed at both ends of the front horizontal mounting bar 520B on the left and right sides thereof for screw fastening by fixing screws 522B-3 of the fixing mounting bar 522A of the rear horizontal mounting bar 520A.

Meanwhile, as referenced in FIGS. 11A and 11B, one end of each of the plurality of vertical mounting bars 530 is coupled to the front horizontal mounting bar 520B. A variable switch panel 540 may be coupled to the other end of each of the plurality of vertical mounting bars 530 through the medium of a predetermined hinge member 543, 544.

In this case, the predetermined hinge member 543, 544 includes a hinge bolt 543 and a hinge nut 544 fastened thereto. A bolt through hole 533 through which the hinge bolt 543 penetrates may be formed in the variable switch panel 540 and the other end of the vertical mounting bar 530.

As the variable switch panel 540 is hinged and coupled to the other end of each of the plurality of vertical mounting bars 530 by the hinge bolt 543 and the hinge nut 544 as described above, the physical length of the transmission line may be changed by an operation of the variable switch panel 540 being freely rotated around a rotation center thereof at a predetermined angle upon up and down moving of the plurality of vertical mounting bars 530.

Meanwhile, a phase shift driving motor 510 may be coupled to a screw guide mounting block 526 that is provided in a support mounting bar 521A of the rear horizontal mounting bar 520A through the medium of a motor installation bracket 515.

The screw guide mounting block 526 further includes a lower coupling stage 523a that is integrally formed on a lower part thereof centering around a screw pole through hole 526h and an upper coupling stage 523b that is integrally formed on an upper part thereof centering around the screw pole through hole 526h. A lower screw pole through hole 523a-h and an upper screw pole through hole 523b-h, which are connected to or communicate with the screw pole through hole 526h, may be formed in the lower coupling stage 523a and the upper coupling stage 523b.

A fixing screw through hole 515h-1 may be formed in the motor installation bracket 515 so that a fixing screw 515s is fastened to a fixing screw fastening hole 525h-2, which is formed in the lower coupling stage 523a of the screw guide mounting block 526, through the fixing screw through hole.

Furthermore, the top of a rotation screw pole 511, which is exposed over the upper screw pole through hole 523b-h of the upper coupling stage 523b of the screw guide mounting block 526 through the upper screw pole through hole 523b-h, may be fixed through the medium of a hinge bush 524 and a C-ring 525.

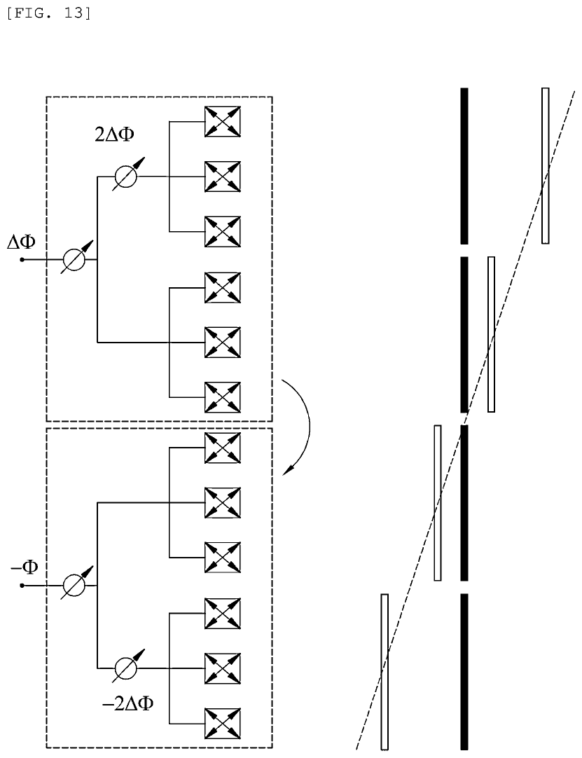

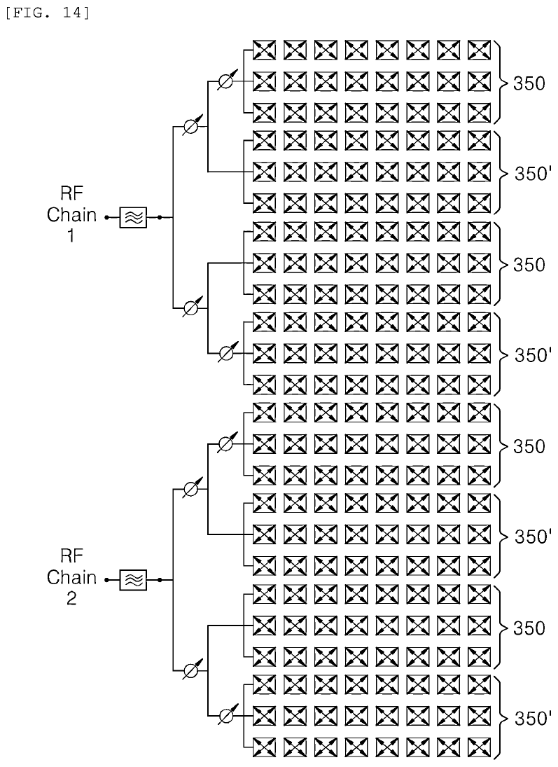

FIG. 13 is a circuit diagram and phase difference diagram for describing the principle of a form of a phase shift that is performed in the RF stage by using the phase shifter 500 of the antenna apparatus 1 according to embodiments of the present disclosure. FIG. 14 is a conceptual diagram for describing a transmission signal channel for 32T32R and phase shift form of the antenna apparatus according to embodiments of the present disclosure.

In general, if the length of the transmission line of each RF chain is changed, the phase of a signal that is supplied to at least two antenna sub-arrays 350, among the four antenna sub-arrays 350, requires a support task at a digital stage in order to implement a mirror symmetry structure.

In the antenna apparatus 1 according to an embodiment of the present disclosure, the phase shifter 500 is for omitting the support task in the digital stage, and may be rotatably provided so that the lengths of a transmission line on one side thereof and a transmission line on the other side thereof are changed at a predetermined ratio by a first electrification pattern terminal (reference numeral not indicated) and second electrification pattern terminal (reference numeral not indicated) of the variable switch panel 540 at a first power failure point (not illustrated) before a power feeding signal input from one TRx module (means transmission and reception elements mounted on the main board or an amplification element part) is branched from each input stage to two output stages and a second power failure point (not illustrated) after the power feeding signal is branched, as referenced in FIG. 14. Therefore, the first power failure point before the branch from the one input stage to the two output stages may implement a desired phase shift value by changing a phase by ΔΦ and −ΔΦ by changing the physical lengths of the transmission lines on the one side and the transmission line on the other side by the first electrification pattern terminal of the variable switch panel 540. The second power failure point, that is, the transmission line of the output stage after the branch into the two output stages may implement a desired phase shift value by changing a phase by 2ΔΦ and −2ΔΦ by changing the physical lengths of the transmission line on the other side by the second electrification pattern terminal of the variable switch panel 540.

In this case, a mirror symmetry structure having the most efficient beamforming performance, such as that referred in FIG. 13, can be implemented because the phase shift values of two antenna sub-arrays 350 and two additional antenna sub-arrays 350′ on the basis of the same phase surface can achieve a linear phase distribution.

In this case, the antenna apparatus 1 according to an embodiment of the present disclosure as referred in FIG. 14 implements beamforming by shifting a phase so that a transmission line before a branch from the input stage of an RF chain to two output stages and a transmission line that connects any one of the two output stages after the branch in the antenna sub-arrays 350 and the additional antenna sub-arrays 350′ provided to implement a transmission line channel for a total of 32T32R have a physical length ratio of a predetermined ratio at one place of the transmission line before the branch and one place of the transmission line after the branch.

Accordingly, a gain of +6 dB is improved compared to an antenna apparatus that has two RF chains, but has a transmission line channel for 32T32R not equipped with the phase shifter 500. A gain of +3 dB is improved compared to an antenna apparatus that has two RF chains and a phase shifter, but has a transmission line channel for 32T32R that is not branched into two output stages. Accordingly, there is an advantage in that a beam having a narrow beam width and a great antenna gain can be radiated.

Furthermore, the antenna apparatus 1 illustrated in FIGS. 13 and 14 according to an embodiment of the present disclosure has advantages in that it can implement beamforming having the same effect as that of a 64T64R antenna apparatus because the phases of four antenna sub-arrays for each RF chain can be changed and it is advantageous in terms of a cost and process compared to a 64T64R antenna apparatus having four RF chains because the antenna apparatus 1 illustrated in FIGS. 13 and 14 has the two RF chains.

The antenna apparatus according to an embodiment of the present disclosure has been described above in detail with reference to the accompanying drawings. However, an embodiment of the present disclosure is not essentially limited to the aforementioned embodiment, and may include various modifications and implementations within an equivalent range thereof by a person having ordinary knowledge in the art to which the present disclosure pertains. Accordingly, the true range of a right of the present disclosure will be said to be defined by the appended claims.

### INDUSTRIAL APPLICABILITY

The present disclosure provides the antenna apparatus capable of implementing beamforming having a great gain, compared to an antenna apparatus not including an additional antenna sub-array, by further constructing an additional antenna sub-array for a branch from the input stage of each RF chain, along with the plurality of antenna sub-arrays that are arranged to construct a predetermined number of RF chains, and performing beam radiation by shifting the phase values of the antenna sub-arrays and the additional antenna sub-array so that the phase values are different from each other by using a phase shifter.

1. An antenna apparatus comprising:
a radiation element module comprising a plurality of antenna sub-arrays provided to be electrically connected to a front of an RF filter and arranged to implement antenna beamforming by constructing a predetermined number of RF chains; and
a phase shifter configured to shift a phase value by changing a ratio of lengths of physical transmission lines for the plurality of antenna sub-arrays at a predetermined ratio,
wherein each of the RF chains of the radiation element module is further arranged so that the antenna sub-array is connected to any one of two output stages that are branched from an input stage of each of the RF chains and an additional antenna sub-array corresponding to the antenna sub-arrays is connected to an output stage of the other of the two output stages.

2. The antenna apparatus according to claim 1, wherein the phase shifter implements a linear phase distribution based on the predetermined ratio with respect to an identical reference phase surface by performing beam radiation by differently shifting phase values of the plurality of antenna sub-arrays and the additional antenna sub-array in a transmission line that constitutes any one of the input stage of each of the RF chains and the two output stages that have been branched.

3. The antenna apparatus according to claim 1, wherein when antenna beamforming through a transmission signal channel for 32T32R is implemented,
the plurality of antenna sub-arrays constitute two RF chains and are arranged to be spaced apart from each other in a vertical (V) direction for each chain, and
the additional antenna sub-array is arranged to be spaced apart from the antenna sub-array in the V direction so that the additional antenna sub-array is branched from an input stage of each of the two RF chains along with the antenna sub-arrays.

4. The antenna apparatus according to claim 3, wherein the phase shifter changes a physical length of each of the transmission lines connected to the plurality of antenna sub-arrays and the additional antenna sub-array corresponding to each of the RF chains for power feeding.

5. The antenna apparatus according to claim 1, wherein:
the phase shifter comprises a variable switch panel comprising a first electrification pattern terminal and a second electrification pattern terminal, and
the radiation element module comprises an antenna board assembly in which the plurality of antenna sub-arrays and the plurality of additional antenna sub-arrays are arranged and a transmission line in which the first electrification pattern terminal and the second electrification pattern terminal come into contact with each other is coupled in a form of a plurality of power feeding strip lines made of a conductive material.

6. The antenna apparatus according to claim 5, wherein the plurality of power feeding strip lines of the antenna board assembly are provided in a variable circuit board on which a variable circuit having a first power failure point and a second power failure point that are electrified by the first electrification pattern terminal and second electrification pattern terminal of the variable switch panel is patternized and printed.

7. The antenna apparatus according to claim 6, wherein the variable circuit board is provided in a form of a printed circuit board made of an FR-4 material.

8. The antenna apparatus according to claim 6, wherein the plurality of power feeding strip lines comprise:
a rear power feeding strip line electrically connected to the variable circuit of the variable circuit board comprising two input stages so that power is supplied from at least two places; and
a front power feeding strip line electrically connected to the rear power feeding strip line, branched and extended to have at least two output stages, and connected to the plurality of antenna sub-arrays and the plurality of additional antenna sub-arrays.

9. The antenna apparatus according to claim 5, wherein the phase shifter implements a phase shift value having a predetermined ratio based on a location where the first electrification pattern terminal and the second electrification pattern terminal come into contact with the transmission line as the variable switch panel is rotated.

10. The antenna apparatus according to claim 1, wherein the radiation element module comprises:
an antenna board assembly comprising a reflecting panel provided to forward reflect antenna beams that are radiated by the plurality of antenna sub-arrays and the additional antenna sub-arrays and a rear panel and a front panel stacked and coupled to a rear surface and front surface of the reflecting panel; and
a plurality of power feeding strip lines arranged in any one of strip line installation slits that penetrate the reflecting panel or that are processed in the rear panel and the front panel in a slit form, arranged for an electrical connection between the plurality of power feeding strip lines and the RF filter, and made of a conductive material,
wherein a material of each of the front panel and the rear panel comprises a plastic resin material of a heterogeneous material that is different from a material of the reflecting panel, and
the rear panel and front panel of the antenna board assembly are integrally manufactured by a dual injection method on the basis of the reflecting panel.

11. The antenna apparatus according to claim 10, wherein a variable circuit board on which a variable circuit having at least two power failure points is patternized and printed so that the two power failure points constitute a part of the physical transmission line that is changed by the phase shifter is constructed on a front surface of the front panel.
